(19) United States
(12) Patent Application Publication
(10) Pub. No.: US 2010/0086765 A1
(43) Pub. Date: Apr. 8, 2010

(54) METHOD OF PROCESSING A COMPOSITE MATERIAL

(75) Inventor: David Graham Inston, Bristol (GB)

Correspondence Address: LOWE HAUPTMAN HAM & BERNER, LLP, 1700 DIAGONAL ROAD, SUITE 300, ALEXANDRIA, VA, 22314, US

(73) Assignee: AIRBUS UK LIMITED, Bristol (UK)

(21) Appl. No.: 12/524,033

(22) PCT Filed: Jan. 31, 2008
(86) PCT No.: PCT/GB08/50064

§ 371 Date: Jul. 22, 2009

(30) Foreign Application Priority Data
Feb. 13, 2007 (GB) 0702781.6

(51) Int. Cl. B29C 70/44; B29C 65/02

(52) U.S. Cl. 428/311.51; 156/285

(57) ABSTRACT

A method of processing a composite material comprising heating a porous layer in contact with the composite material above its melting point whereby it melts and becomes incorporated into the composite material. The material may be formed by a matrix diffusion process. In this case the porous layer acts as a distribution layer. Alternatively the material may be formed as a stack of prepregs. In this case the porous layer acts as a breather layer. The porous layer may comprise a polysulphone or polyethersulphone which increases the toughness of the material.

### FIELD OF THE INVENTION

The present invention relates to a method and apparatus for processing a composite material, and a charge and porous layer for use in such a method. The method is particularly suited for modifying an epoxy resin composite material, but is not limited to such a material.

### BACKGROUND OF THE INVENTION

A problem with epoxy resin composite materials is that the resin can be quite brittle. A known solution to this problem is to add specific modifiers to the resin, such as polysulphone (PSu) or polyethersulphone (PES).

These modifiers are conventionally added to the resin in the form of a powder. This tends to give a very marked increase in resin viscosity. Whilst this viscosity increase can be beneficial if the composite material is provided as a pre-impregnated part (conventionally known as a “prepreg”) it makes it difficult or impossible to transport the resin into reinforcement material under vacuum pressure, as required by many resin infusion processes.

One such resin infusion process is the so-called SCRIMP process (Seeman Composites Resin Infusion Moulding Process). This involves the use of a resin distribution medium (RDM) which conducts resin over and through an assembled dry fibre pre-form supported on a single-sided mould tool. After the RDM has been used, it is discarded.

### SUMMARY OF THE INVENTION

A first aspect of the invention provides a method of processing a composite material, the method comprising heating a porous layer in contact with the composite material above its melting point whereby it melts and is incorporated into the composite material.

A second aspect of the invention provides a thermoplastic porous layer suitable for use in the method of the first aspect of the invention.

The porous nature of the layer enables it to be used in a previous processing step in which the interstitial volumes in the porous layer are evacuated, and the porous layer either transports matrix in a fluid state, or acts as a breather layer. The porous layer typically modifies a physical property of the composite material after it has become incorporated. For instance the porous layer may modify the toughness, compression strength and/or modulus of the composite material.

The porous layer may be incorporated completely into the composite material, or may be incorporated only partially leaving part of the layer intact. The porous layer may dissolve into the composite material to form a homogenous mixture, or may disperse into the composite material as a separate phase.

In certain embodiments of the invention, the method further comprises forming the composite material by:
evacuating a reinforcement material in contact with the porous layer; and
infusing the evacuated reinforcement material with a matrix in a fluid state, the matrix flowing through the porous layer and into the reinforcement material.

In this case the porous layer performs dual functions:
it acts as a distribution layer which transports fluid matrix during the infusion process (i.e. it performs a similar function to the RDM in the SCRIMP process); and
it modifies a property (for instance toughness, compression strength and/or modulus) of the composite material after it has become incorporated into the composite material.

The reinforcement material may be evacuated between a pair of rigid mould tools (for instance as part of a resin transfer moulding process), but more preferably the reinforcement material is evacuated under a flexible vacuum bag.

A third aspect of the invention provides a charge for manufacturing a composite material, the charge comprising a dry reinforcement material in contact with a thermoplastic porous layer.

In other embodiments of the invention, the method further comprises forming the composite material by laying a stack of plies of pre-impregnated reinforcement material (commonly known as “prepreg”). In this case, no infusion step is generally required. Preferably the method further comprises evacuating the composite material in contact with the porous layer, typically under a flexible vacuum bag. In this case the porous layer can act as a “breather” layer during evacuation.

A fourth aspect of the invention provides a charge for manufacturing a composite material, the charge comprising one or more plies, each ply comprising a reinforcement material pre-impregnated with a matrix, at least one of the plies being in contact with a thermoplastic porous layer.

The method typically further comprises evacuating the composite material at the same time as the porous layer becomes incorporated into the composite material. In this case, the vacuum assists the incorporation of the porous layer into the composite material. The composite material may be evacuated between a pair of rigid mould tools, but more preferably the composite material is evacuated under a flexible vacuum bag.

Typically the composite material comprises a thermosetting matrix phase with a cure temperature above the melting point of the porous layer, and the method further comprises curing the matrix phase.

Preferably the method further comprises cooling the composite material after the porous layer has become incorporated, whereby the incorporated material solidifies into an array of particles.

Typically the porous layer is formed from a three-dimensional network of fibres: for instance a woven or knitted network.

Typically the material forming the porous layer comprises a polysulphone or polyethersulphone.

The porous layer may comprise an external layer which contacts an external surface of the composite material, or an internal layer which contacts an internal surface of the composite material. Two or more external and/or internal layers may be provided, and in this case the layers are preferably in contact at one or more contact points which may be outside the composite material.

A fourth aspect of the invention provides apparatus for manufacturing a composite material, the apparatus comprising:
a mould tool;
a thermoplastic porous layer; and
a flexible vacuum bag for forming a sealed envelope, the vacuum bag having a vacuum port for evacuating the sealed envelope.

### BRIEF DESCRIPTION OF THE DRAWINGS

Embodiments of the invention will now be described with reference to the accompanying drawings, in which:

FIG. 1 is a schematic cross-sectional view of a first method of manufacturing a composite material;

FIG. 2 is a schematic cross-sectional view of a second method of manufacturing a composite material; and

FIG. 3 is a schematic cross-sectional view of a third method of manufacturing a composite material, employing a prepreg charge.

### DETAILED DESCRIPTION OF EMBODIMENT(S)

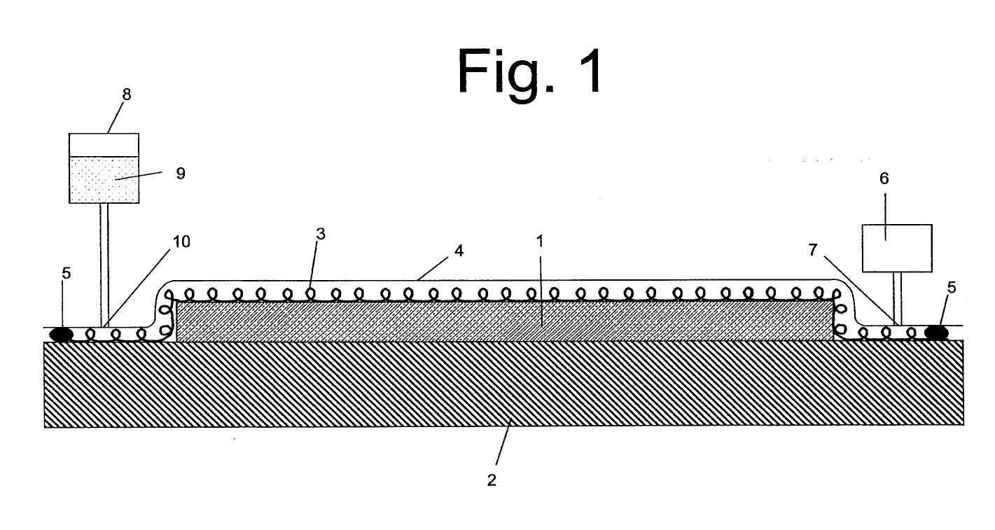

FIG. 1 shows a first variant of a method of manufacturing a composite material. A pre-form 1 is laid onto a single-sided mould tool 2. The pre-form 1 comprises a stack of layers of dry carbon-fibre, or any other suitable reinforcement material. A resin distribution layer 3 is then laid onto the pre-form 1.

The layer 3 is formed from a knitted or woven fabric of monofilament fibres, the fibres being formed from a specific grade of functionally reactive polysulphone (PSu), polyethersulphone (PES), or any other suitable thermoplastic material. An example of a suitable polymer is Radel A105P, available from Solvay Advanced Polymers. Typically the material is either hydroxy, amine or carboxy functionalised.

The fibres are typically 0.1-0.2 mm in diameter, the weight of the layer is typically of the order of 120 gsm, and the thickness of the layer is typically in the range of 1.6 mm to 1.8 mm.

A suitable fabric is “N1031” available from Newbury Engineered Textiles Limited, of Newbury, United Kingdom.

The lay-up is then completed by a release film or peel ply (not shown).

A flexible vacuum bag 4 is then laid onto the release film to form an envelope over the lay-up. The envelope is sealed against the mould tool 4 by a sealing member 5 which runs round the periphery of the lay-up.

The vacuum bag 4 has a vacuum port 7 connected to a vacuum device 6 via a resin trap (not shown), and an infusion port 10 for introducing an epoxy resin matrix 9 stored in a resin bath 8 into the envelope.

The pre-form is then infused and cured by the following steps:
1. The vacuum device 6 is operated to partially evacuate the sealed envelope. This causes the vacuum bag 4 to press against the lay-up and compress the pre-form 1. However the resin distribution layer 3 (being formed from a relatively rigid three-dimensional network of fibres) can support at least 1 atmosphere of pressure so is compressed to a lesser extent and retains its porous nature.
2. The lay-up and the epoxy resin 9 are heated up to an infusion temperature of approximately 50° C.
3. The pre-form is infused by introducing the epoxy resin 9 into the evacuated envelope. The resin flows through the evacuated interstitial volumes of the porous structure of the resin distribution layer 3, and wets the pre-form 1 from above. When the resin front reaches the vacuum port 7, it is output into the resin trap (not shown).
4. Infusion is complete when air-free resin is being continuously output at the vacuum port 7.
5. After infusion is complete, the resin distribution layer 3 is heated above its melting point (typically approximately 150° C.) whereby it melts and dissolves into the matrix-infused pre-form. Vacuum pressure is maintained during this step, and the vacuum (assisted by heat) forces the dissolved material to become incorporated into the part. The dissolved material will be relatively uniformly distributed through the thickness of the part. Any non-uniformity is likely to result in an increased concentration towards the upper surface of the part, which may be beneficial if increased toughness is required at that surface.
6. The temperature is increased further to approximately 180° C., at which point the resin cures. The dissolved material precipitates out of the resin to form an array of fine liquid droplets. This material is chemically resistant to the resin at the curing temperature.
7. The composite is cooled to below the melting point of the PSu or PES which is dissolved in the resin. As a result it solidifies into an array of particles which increase the toughness of the resin.
8. The vacuum is released, and the vacuum bag peeled off from the cured composite part.
9. The composite part is lifted off the mould tool 2.

In the example of FIG. 1, only a single resin distribution layer 3 is used, which is laid in contact with the upper external surface of the pre-form 1.

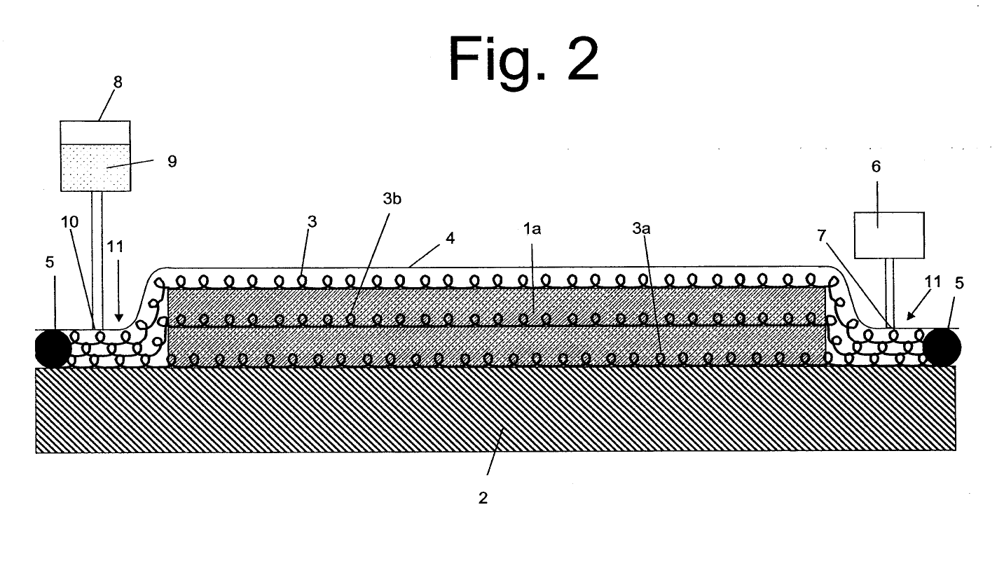

In a second variant shown in FIG. 2 the lay-up is formed with two additional resin distribution layers 3a, 3b. Common elements are given the same reference numerals as in FIGS. 1 and 2.

The lower resin distribution layer 3a is first laid onto the mould tool 4, and the lower half of the pre-form 1a is laid on top of it. Note that the pre-form 1a is thicker than the pre-form 1 in FIG. 1. In common with the upper layer 3, the lower layer 3a contacts an external surface of the pre-form 1a. In addition to the external layers 3,3a, an internal resin distribution layer 3b is embedded within the interior of the pre-form 1a. This layer 3b is laid when the lower half of the pre-form has been laid onto the mould tool, the upper half of the pre-form being laid on top of the layer 3b.

As can be seen in FIG. 2, the layers 3,3a,3b are separated by the reinforcement material, but converge towards contact points 11 outside the pre-form. This ensures a consistent and uniform vacuum to transport the resin evenly through the three layers 3,3a,3b.

In comparison with FIG. 1, the larger number of resin distribution layers in the arrangement of FIG. 2 results in a higher concentration of dissolved material, and more uniform distribution through the thickness of the pre-form.

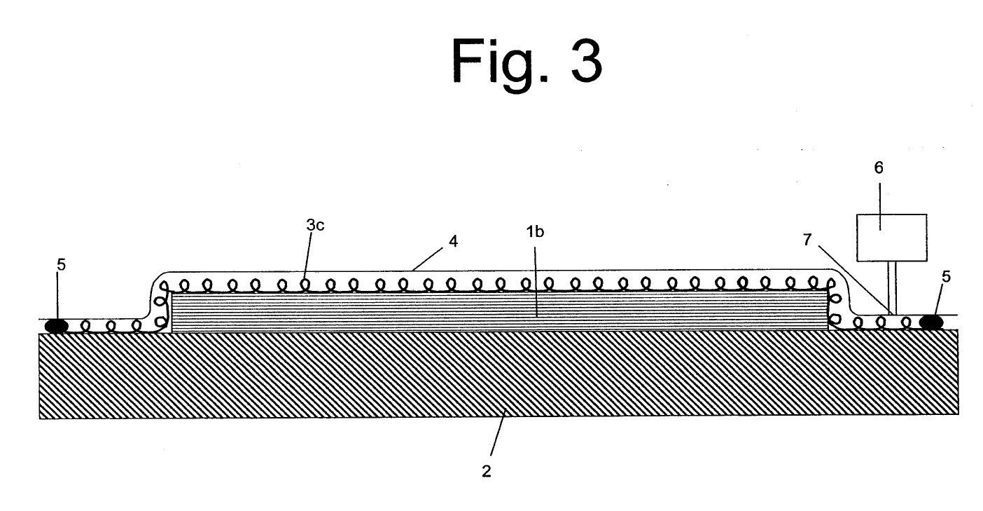

The third variant of FIG. 3 employs a composite charge 1b formed from a stack of layers of prepreg tape, in contrast with the dry fibre pre-form charges 1,1a employed in FIGS. 1 and 2. Common elements are given the same reference numerals as in FIGS. 1 and 2.

Note that the infusion port and resin bath are omitted in FIG. 3, although the vacuum bag 4 (and associated vacuum system) is included to consolidate the charge during curing. In a conventional prepreg lay-up, a breather layer (for instance Airweave™ cloth) is placed between the prepreg and vacuum bag to provide a gas flow path permitting the removal of air and other gasses during the cure process. In the variant of FIG. 3 the breather layer is replaced by a layer 3c having similar characteristics to the resin distribution layer 3 shown in FIGS. 1 and 2: that is, a knitted or woven fabric of monofilament fibres, the fibres being formed from a specific grade of functionally reactive polysulphone (PSu), polyethersulphone (PES), or any other suitable thermoplastic material.

The charge 1b is then cured by the following steps:
1. The vacuum device 6 is operated to evacuate the sealed envelope. This causes the vacuum bag 4 to press against the lay-up and compress the charge 1b.
2. The layer 3c acts as a breather layer, permitting gasses to flow out of the lay-up through its evacuated interstitial volumes.
3. The layer 3c is heated above its melting point (typically approximately 150° C.) whereby it melts and dissolves into the prepreg charge. Vacuum pressure assisted by heat forces the dissolved material to become incorporated into the part.
4. The temperature is increased further to approximately 180° C., at which point the resin cures. The dissolved material precipitates out of the resin to form an array of fine liquid droplets. This material is chemically resistant to the resin up to the curing temperature.
5. The composite is cooled to below the melting point of the PSu or PES which is dissolved in the resin. As a result it solidifies into an array of particles which increase the toughness of the resin.
6. The vacuum is released, and the vacuum bag peeled off from the cured composite part.
7. The composite part is lifted off the mould tool 2.

Note that the process does not involve an infusion step: hence the layer 3c does not perform the resin distribution function of the equivalent layers 3 in FIGS. 1 and 2. However the porous nature of the layer 3c makes it a suitable substitute for a conventional breather layer.

Although the invention has been described above with reference to one or more preferred embodiments, it will be appreciated that various changes or modifications may be made without departing from the scope of the invention as defined in the appended claims.

1. A method of processing a composite material, the method comprising heating a porous layer in contact with the composite material above its melting point whereby it melts and is incorporated into the composite material.

2. The method of claim 1 further comprising forming the composite material by:
evacuating a reinforcement material in contact with the porous layer; and
infusing the evacuated reinforcement material with a matrix in a fluid state, the matrix flowing through the porous layer and into the reinforcement material.

3. The method of claim 2 wherein the reinforcement material and porous layer are evacuated under a flexible vacuum bag.

4. The method of claim 1 further comprising forming the composite material by laying a stack of plies of pre-impregnated reinforcement material.

5. The method of claim 1 further comprising evacuating the composite material in contact with the porous layer.

6. The method of claim 5 wherein the composite material and porous layer are evacuated under a flexible vacuum bag.

7. The method of claim 1 further comprising evacuating the composite material at the same time as the porous layer is incorporated into the composite material.

8. The method of claim 1 wherein the composite material comprises a thermosetting matrix phase with a cure temperature above the melting point of the porous layer, and wherein the method further comprises curing the matrix phase.

9. The method of claim 1 further comprising cooling the composite material after the porous layer has melted, whereby the dispersed material solidifies into an array of particles which increase the toughness of the composite material.

10. The method of claim 1 wherein the porous layer is formed from a three-dimensional network of fibres.

11. The method of claim 1 wherein the material forming the porous layer comprises a polysulphone or polyethersulphone.

12. The method of claim 1 wherein the porous layer comprises an external layer which contacts an external surface of the composite material.

13. The method of claim 1 wherein the porous layer comprises an internal layer which contacts an internal surface of the composite material.

14. The method of claim 1 comprising heating two or more separate porous layers in contact with the composite material above their melting point whereby they melt and are incorporated into the composite material.

15. The method of claim 14 wherein the two or more porous layers are separate within the composite material, and converge towards one or more contact points outside the composite material.

16. The method of claim 1 further comprising evacuating interstitial volumes in the porous layer.

17. A composite material manufactured by the method of claim 1, the material comprising a polysulphone or polyethersulphone.

18. A thermoplastic porous layer suitable for use in the method of claim 1, wherein the material forming the layer comprises a polysulphone or polyethersulphone.

19. The layer of claim 18 formed from a three-dimensional network of fibres.

20. The layer of claim 19 wherein the network is a woven or knitted network.

21. (canceled)

22. (canceled)

23. (canceled)

24. (canceled)

25. (canceled)

26. (canceled)

27. (canceled)

28. (canceled)
